(19) United States
(12) Patent Application Publication
(10) Pub. No.: US 2004/0249701 A1
(43) Pub. Date: Dec. 9, 2004

(54) Industry injury/safety, reporting and investigative system and method

(76) Inventor: Daniel A. Schwarz, Philadelphia, PA (US)

Correspondence Address: RATNERPRESTIA, P O BOX 980, VALLEY FORGE, PA, 19482-0980, US

(21) Appl. No.: 10/829,739

(22) Filed: Apr. 22, 2004

Related U.S. Application Data
(60) Provisional application No. 60/464,505, filed on Apr. 22, 2003.

(51) Int. Cl. G06F 17/60

(52) U.S. Cl. 705/11

(57) ABSTRACT

A groundbreaking Injury Reporting and Safety System and method that may be utilized by labor and industry in order to monitor and track repetitive causes and types of workplace injuries and hazardous exposures. The Injury Reporting and Safety System and method is an accurate, efficient and reliable mechanism for reporting and recording, as well as analyzing and coordinating, causes of worksite injury and hazardous exposure data. The purpose of this system is to promote jobsite safety and protect the legal interests of injured workers. Through the monitoring of repetitive causes and types of worksite injuries, the Injury Reporting and Safety System will provide industry specific data and information which can be furnished to contractors, government agencies, management and manufacturers, etc., in order for these entities to correct and remedy dangerous and hazardous worksite conditions, equipment and exposures. Furthermore, the Injury Reporting and Safety System provides not only a local, but a national mechanism to analyze and compare repetitive causes and types of worksite injuries and hazardous exposures as a means of promoting a safer work environment.

### RELATED APPLICATION

This application claims the benefit of priority of U.S. Provisional Patent Application No. 60/464,505, filed on Apr. 22, 2003, the contents of which are incorporated in this application by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present, unique invention generally relates to labor and industry Injury Reporting and Safety Systems. More specifically, the present invention relates to an Injury Reporting and Safety System and method which may be utilized by labor and industry in order to accurately, efficiently and reliably report and record causes and types of worksite injuries and hazardous exposures for the purpose of analyzing, coordinating and protecting the interests of injured individuals and workers as well as a means of promoting a safer work environment for the benefit of both labor and industry.

### BACKGROUND OF THE INVENTION

In the past, contractors, employers, government agencies, management and manufacturers have controlled and maintained labor and industry worksite safety and injury information. This data and information not only affects the safety of labor and industry but also their legal rights and interests. Unfortunately, labor and industry's access to this data and information has been limited by an inability to freely control, monitor, organize, access, report and understand such data and information. Inaccurate and imprecise reporting and recording practices have made this data and information unreliable for future use in order to analyze, compare and understand cause and types of injury trends within an industry.

For example, tens of thousands of building trade workers such as boilermakers, carpenters, dock builders, electricians, longshoremen, plumbers, sprinkler fitters and steamfitters have been exposed to asbestos. Due to the fact that no comprehensive Injury Reporting or Safety System was in effect to accurately and properly report, records, analyze and monitor repetitive types of hazardous occupational exposure, industry and labor were left with only imprecise and inadequate worksite paper records. Furthermore, many of these records were obviously only snippets of larger pieces of information collected in the past, without analysis, thus making it nearly impossible to identify the dates, locations and sources of the occupational asbestos exposure.

OSHA is another example of the inability of present systems to provide the information, access and reporting needed by workers. OSHA is a government agency that enforces worksite safety standards and monitors worksite injuries and safety through a reporting system known as OSHA 200 logs. The OSHA 200/300 log is the government recording system of all workplace injuries. The following information is recorded in OSHA 200/300 logs after a workplace injury occurs: death, one or more lost workdays, loss of consciousness, transfer to another job and medical treatment (other than first aid).

The OSHA system is flawed in what it delivers for the benefit of workers for various reasons. Initially, OSHA 200/300 logs are reported well after a worksite incident takes place. Often facts and evidence are distorted or lost as a result of this delay. This means that OSHA does not provide for immediate documentation and a contemporaneous recording of both facts and evidence in order to prevent future potential distortion or loss of worksite injury information.

Second, OSHA's recording system provides only a skeletal understanding of a worksite injury event. Numerous causes of repetitive sources of injury are clearly excluded by the OSHA system. Location of incident, equipment type, vehicle type, aircraft type, product type, equipment number, product number, manufacturers' identity, type of occupational exposure, name of contractors or parties, cause of accident, witnesses present, photographs taken, type of body part injured and injury diagnoses are some examples of relevant worksite incident and injury data which is not recorded in the OSHA 200/300 logs. The lack of this information prevents OSHA from accurately and efficiently analyzing and comparing industry specific causes of repetitive worksite injuries. The OSHA 200/300 logs also fail to record and track all witnesses, statements and photographs.

Third, the OSHA 200/300 has no mechanism or system for providing or recording an investigative summary following a worksite incident and injury. For example, no investigative findings are made regarding, what caused the worksite incident or injury, how the incident was preventable, was the incident a safety violation and, if so, why, what corrective measurers have occurred since the incident, a description of the severity of the injury, witness statements and photographs. Investigative findings can be critical in providing more comprehensive worksite incident and injury data than what is contained in an initial incident report or OSHA 200/300 log.

Finally, all OSHA 200/300 reporting is documented on a case by case basis. Each individual report is not coded or situated for cross referencing the recorded data information for analysis or comparison of repetitive causes and sources of injuries. Instead, each individual OSHA 200/300 log is evaluated and reviewed one report at a time in order to locate relevant worksite incident or injury information. Therefore, needless time and energy is spent reviewing all OSHA 200/300 logs which have been filed instead of their relevance to a specific query in order to analyze and compare log records of similarly situated types and causes of repetitive injuries.

There is currently no known, viable way to identify and monitor similar causes, sources and types of worksite injuries either on a local or national level. No known system exists for analyzing and comparing similarly situated causes, sources and types of occupational exposure or injuries in order to establish and/or improve safety standards for contractors, jobsites, equipment, products, etc. as well as providing a mechanism to determine violators of these standards. It is a monumental, if not impossible task to assimilate and coordinate such information, under current systems. Similarly, it is just as difficult if not impossible to sufficiently protect the legal rights of the individual laborer in light of the vast complexities in accumulating worksite safety, incident and injury information.

### SUMMARY OF THE INVENTION

The present invention is a unique program, comprised of an Injury Reporting and Safety System, utilized by both labor and industry, in order to report, record, monitor and track repetitive causes and types of workplace injuries and exposures for the purpose of promoting jobsite safety as well as the legal rights of injured workers. In one embodiment, creating an accurate, efficient and reliable reporting system for labor and industry to communicate and report causes of workplace injuries, the Injury Reporting and Safety System provides the framework for relevant workplace data and information which is required in order to analyze and coordinate repetitive causes and types of injuries and occupational exposures. This data and information reported by the injured worker is coordinated and formulated on the Injury Reporting and Safety System Identification Card. This data and information is thereafter recorded into a second embodiment which is the Injury Reporting and Safety System Incident Report and database.

In a third embodiment, the Injury Reporting and Safety System database query software coordinates repetitive causes and types of injuries and occupational exposures through numerical coding and field designations contained in the Injury Reporting and Safety System Incident Report background information categories. This information provides the necessary mechanism to analyze and organize the reported industry specific causes and types of injury information in a manner which identifies the parties, location, type of accident, type of equipment, equipment number, manufacturer identity, exposure type, type of injury and body part involved in said incident. Each industry specific background category may have a pull down menu in order to simplify the coordination of information by the data entry programmer. The aforesaid information contained in each category is uniquely designed to be industry specific in order to address the different types of equipment and causes of injuries in different industries.

In a fourth embodiment, the Injury Reporting and Safety System provides an Investigative Summary framework to supplement the Injury Reporting and Safety System Incident Report thus insuring that additional data and information may be accumulated at a subsequent date in order to provide further insight to repetitive causes and types of injuries.

In a fifth embodiment, through the monitoring of repetitive causes and types of worksite injuries, the Injury Reporting and Safety System will provide industry specific data and information which can be furnished to contractors, government agencies, management and manufacturers, etc., in order to correct, change and modify dangerous and hazardous worksite conditions, equipment and exposures.

In an additional embodiment, the Injury Reporting and Safety System allows for analysis and comparison, intra-industry, among other similarly situated parties in labor and industry on a local and also national level.

### BRIEF DESCRIPTION OF THE DRAWINGS

The present invention will now be described by way of non-limiting example, with reference to the attached drawings in which:

FIG. 1a is a front view of an exemplary Identification Card for an airline worker in accordance with the present invention;

FIG. 1b is a rear view of an exemplary Identification Card for an airline worker in accordance with the present invention;

FIG. 2a is a front view of an exemplary Identification Card for a pipe trade worker in accordance with the present invention;

FIG. 2b is a rear view of an exemplary Identification Card for a pipe trade worker in accordance with the present invention;

FIG. 3 is an exemplary Airline Industry Incident Report entry screen in accordance with the present invention;

FIG. 4 is an exemplary Pipe Trade Industry Incident Report entry screen in accordance with the present invention;

FIG. 5 is an exemplary Airline Industry Investigative Summary entry screen in accordance with the present invention;

FIG. 6 an exemplary Pipe Trade Industry Investigative Summary entry screen in accordance with the present invention;

FIG. 7a is an exemplary Airline Industry Database Query entry screen in accordance with the present invention;

FIG. 7b is an exemplary Airline Industry Database Query screen with industry examples in accordance with the present invention; Categories

FIG. 8a is an exemplary Pipe Trade Industry Database Query entry screen in accordance with the present invention;

FIG. 8b is an exemplary Pipe Trade Industry Database Query screen with industry examples in accordance with the present invention;

FIGS. 9a-f are exemplary tables showing injuries and associated codes in accordance with the present invention; and

FIG. 10 is a flow diagram illustrating how data and information may be exchanged and networked by labor and industry in accordance with the present invention;

### DETAILED DESCRIPTION OF THE INVENTION

The Injury Reporting and Safety System (and Method) has been uniquely designed to provide access to reliable data and information related to causes and types of injuries which may be shared by labor and industry in order to increase job safety. Such data and information may also be utilized to reduce repetitive causes and types of work related injuries. In addition, this system may act as a mechanism to preserve the injured laborer's respective legal rights. Moreover, through the monitoring of repetitive causes and types of worksite injuries, the Injury Reporting and Safety System will provide industry specific data and information which can be furnished to contractors, government agencies, management and manufacturers, etc., in order for these entities to correct, change and remedy dangerous and hazardous conditions, equipment and exposures.

Specifically, the first element of the Injury Reporting component of the Injury Reporting and Safety System has been uniquely created and designed for labor and industry to implement in order to accurately report and communicate various causes and types of work related injuries and exposures. By accurately reporting, organizing and monitoring various causes and types of work site injuries, job site safety within an industry will be dramatically improved.

Since such a comprehensive system has never previously been utilized, the Injury Reporting and Safety System has been designed to simplify how a worksite injury is communicated and what is reported. In order to simplify the reporting elements of a worksite injury, the Injury Reporting and Safety System Identification Card has been created for an injured worker's use following a worksite injury. The Injury Reporting Identification Card contains information categories which an individual must report into the Injury Reporting and Safety System. The Injury Reporting Identification Card information categories provide individualized, specific instructions for what a laborer or worker is to report following his work related incident and injury. When this data and information is accurately reported into the Injury Reporting and Safety System database, an accurate worksite record of the underlying worksite event and injury can be properly maintained by labor and industry.

The industry specific Identification Card category information includes data such as name, address, union, identification number, where the injury occurred, type of accident, type of equipment, equipment number, manufacturer's name, type of exposure, type of injury and body part injured. This reporting framework promotes not only organization and uniformity in reporting worksite injuries but provides and preserves reliable data and information required to analyze, compare and understand repetitive causes and types of injuries in order to improve industry safety.

The second element of reporting the actual worksite injury data and information as part of the Injury Reporting and Safety System, is how this data is reported. The Injury Reporting and Safety System accomplishes this through computer data entry which involves either directly inputting worksite injury information into the Injury Reporting and Safety System computer database or by telephone. A 1-(800) telephone number enables the injured laborer to easily report said information and data contained on the Identification Card to a data entry programmer. The data and information may also be verbally reported or entered directly into the Injury Reporting and Safety System data base by a co-worker, shop steward or foreman who reports or enters the worksite injury information by computer on site.

Reporting the aforementioned data and information into the Injury Reporting and Safety System should generally require no more than three (3) to five (5) minutes of an individual's time regardless of the location of the worksite injury. However, in order to prevent against extended periods of delay with regard to the reporting of worksite cause and injury information, the 1-(800) telephone number utilized to report said incident may also be accessed by use of cellular phones. This will promote a faster and more efficient mechanism for reporting and recording of said data and information into the Injury Reporting and Safety System database.

The data and information to be reported, as stated above, is directly set forth on the Identification Card information categories. This data and information directly corresponds with the Injury Reporting and Safety System Incident Report background information categories described below. By creating and developing this consistency between the Identification Card and Incident Report information categories, this uniformity further assists and simplifies the duties of the data entry programmer in accumulating and entering the relevant information into the Injury Reporting and Safety System. This consistency will also eliminate potential confusion between the individual reporting the worksite incident and the data programmer recording same. Thus, the Injury Reporting and Safety System Incident Report not only provides the first contemporaneous recording of worksite injury data and information controlled by labor and industry but is further designed to properly coordinate, maintain and organize the factual elements of the causes and types of worksite injuries for future analysis and use.

The next phase of the Injury Reporting and Safety System is the recording of relevant worksite cause of injury data and information which is briefly described above. Upon providing the programmer with the worker's name, address, telephone and identification number, a series of industry specific worksite injury questions, consistent with the Injury Reporting and Safety System Identification Card information categories as well as the background information categories contained in the Incident Report, are asked to the injured laborer or worker (or co-worker if the injured worker is unable to communicate). These questions determine specifically how, when, where and what caused the worksite injury and what parts of the body were injured as a result of same. The Injury Reporting and Safety System Incident Report further provides and records a brief contemporaneous statement regarding the incident, witnesses, names, photographs and medical treatment information regarding the underlying worksite event and injury.

One of the most critical elements regarding the Injury Reporting and Safety System Incident Report relates to the recording of the Incident Report background information categories. These background information categories have corresponding computer software fields and a numerical coding system which has been specifically and uniquely invented for the Injury Reporting and Safety System in order to enable labor and industry to analyze and compare similar causes and types of injuries within an industry. These industry specific background information categories include information such as where the injury occurred, type of accident, type of equipment, equipment number, manufacturer's name, type of exposure, type of injury and body part injured. A pull down menu for each category may also be used in order to expedite the recording of such information. Each industry could also further add to and modify their respective informational categories to include industry specific types of equipment, exposure and/or causes of accidents for analysis and comparison. However, as stated above, the Identification Card information categories and Incident Report background information categories will be consistent and uniform.

Following the recording of the worksite injury data into the Incident Report background information categories, these categories are directly linked through a unique computer software program into an industry specific query database. Contained in this industry specific query database are all Incident Reports, as well as the background information categories, which are reported and recorded within the industry directly into the Injury Reporting and Safety System. The Incident Report background information categories, as stated above, are designated with individualized fields or numerical coding for the purpose of analyzing and comparing industry specific repetitive causes and types of worksite injury. Therefore, the industry specific query database categories directly correlate with the Identification Card information categories and the Incident Report background information categories enabling the Injury Reporting and Safety System software to analyze and compare worksite causes and injury data in an accurate and reliable manner. The industry specific query database categories also include information such as where the injury occurred, type of accident, type of equipment, aircraft or vehicle type, equipment number, manufacturer's name, type of exposure, type of injury and body part injured. Since the query database is also linked to the Incident Reporting Systems, the injured worker's name, identification number and union information may also be searched. In addition, the industry specific database query categories may also utilize software pull down menus in order to expedite a search within a specific informational category.

By entering the appropriate industry specific category information which is being reviewed for analysis and comparison, a query may be initiated by labor or industry further to understand repetitive causes of injuries within an industry. For example, a query may be initiated to analyze all knee injuries related to stepping off an airport belt loader. This query may be further modified to include all knee injuries resulting from an airport belt loader manufactured by a certain company. This query may also be modified to study all types of injuries caused by an airport belt loader.

By accurately reporting and recording work related incidents and injuries through the Injury Reporting and Safety System process, an efficient and reliable mechanism now exists for labor and industry to analyze and compare worksite safety and repetitive injury issues. By comparing repetitive causes of injuries through the industry specific Injury Reporting and Safety System database fields and numerical codes, worksite safety will increase, while repetitive types of injuries may be reduced by eliminating similarly situated unsafe work environments.

A third component of the Injury Reporting and Safety System is the Investigative Summary Report which is a supplemental report which labor and industry may utilize in order to further analyze and evaluate the causes of a worksite injury. All Injury Reporting and Safety System Incident Reports and industry specific database queries are directly linked to the Investigative Summary Report in order to provide a more comprehensive analysis of a worksite incident. The procedure leading to the Investigative Summary may be conducted by industry and/or labor safety coordinators, investigators or other experts in order to document their respective findings independent of the initial Incident Report.

The Investigative Findings include, but are not limited to, the reporting and recording of the following information:

1) A narrative statement regarding the worksite incident;

2) What caused the worksite incident;

3) How was the incident preventable;

4) Was the cause of the incident a safety violation and, if so, why;

5) What corrective measures have occurred since the incident;

6) A description of the nature and severity of the injury;

7) Witness statements;

8) Photographs;

9) Parties notified;

10) Date completed and who completed same.

The advantage of having labor and industry report and record their respective investigative findings is initially control of data for safety and injury trend analysis which has never been coordinated in any type of systematic and uniform manner. The Injury Reporting and Safety System Identification Card instructs labor and industry what to report immediately when a worksite injury or exposure occurs. The Injury Reporting and Safety System Incident Report provides the contemporaneous recording of the causes and types of worksite injury which occurs within an industry for future use in order to analyze safety and injury trends as well as preserve and protect laborer's legal rights.

The Investigative Summary provides a reporting and recording mechanism to further analyze and understand the cause and types of injuries which occur within an industry. By investigating causes of worksite injuries, relevant data and information may be utilized by labor and industry in analyzing, comparing and understanding repetitive causes of work related injuries.

The Investigative Summary is also used to investigate more fully, those worksite injuries which may be more extensive in nature or require specialized concern. Moreover, the Investigative Summary and Incident Report and Database query information may further be used for comparison in order to recognize trends involving causes of workplace injuries on not only a local but also a national level through the computer networking process established through the Injury Reporting and Safety System web server.

Through the implementation of Injury Reporting and Safety System, labor and industry will no longer be at the mercy of delayed, imprecise, incomplete, inefficient, unorganized and non-accessible work place injury information. In the past, such comprehensive information was unavailable for analysis and was controlled by contractors, employers and governmental agencies. The Injury Reporting and Safety System corrects this deficiency and affords labor and industry a contemporaneous and complete mechanism and system for accurately and efficiently reporting, recording and analyzing worksite injury data and information and especially those injuries with repetitive causes. Moreover, through the monitoring of repetitive causes and types of worksite injuries, the Injury Reporting and Safety System will provide industry specific data and information which can be furnished to contractors, government agencies, management and manufacturers, etc., in order for these entities to correct and remedy dangerous and hazardous conditions, equipment and exposures.

For example, by utilizing the Injury Reporting and Safety System computer database, workers who contract asbestos or other forms of hazardous occupational exposure now have a mechanism for accurately recording and maintaining this information for future use should the exposure subsequently result in disease or injury. Moreover, the legal rights of the worker and his/her family members are now documented and preserved, as all necessary parties and causes related to the exposure are identified for analysis in the Injury Reporting and Safety Systems database. In addition, similarly situated workers will further be able to utilize this data to analyze and compare repetitive injuries resulting from similar types of occupational exposure. Obviously, this information will not only improve worksite safety but will also serve to protect the legal rights of the exposed injured workers.

The Injury Reporting and Safety System Database Query eliminates the inefficient and incomplete OSHA process by enabling labor and industry to analyze, compare and cross reference worksite incident and injury data and information. Retrieval of repetitive causes, sources and types of injury information may be accomplished by identifying fields or numerical codes which include, but are not limited to, the name of the jobsite, contractor, parties involved, manufacturer's name, equipment type, product type, vehicle type, aircraft type, manufacturer of equipment number, occupational exposure type, causes of accidents and/or injury types.

By entering the appropriate and required cause, source and/or types of injury information into the Injury Reporting and Safety System Database Query, relevant data may be tracked for safety trend analysis. In addition, retrieval of injury type, such as fracture, sprain, bee sting or laceration, or part of body, such as hand, back, arm, leg, foot, ankle or neck may also be entered into the Injury Reporting and Safety System Database Query. Through individual or mixed data, query relevant data may be tracked for injury trend analysis. By conducting an appropriate field search, all worksite injuries properly reported and recorded through the Injury Reporting and Safety System may be retrieved for analysis and comparison.

Another practical example of how the Injury Reporting and Safety System may be utilized can be demonstrated from analysis of injuries resulting from airline baggage carts. If a specific design and type of airline baggage cart causes repetitive instances of injuries to airline workers, a query may be conducted through the Injury Reporting and Safety System Database Query in order to analyze and compare the frequency of such workplace injuries which were reported by workers in accordance with the system.

By determining that repetitive injuries are caused by a certain manufacturer's product design, necessary changes to protect worksite safety may be accomplished by contacting the appropriate manufacturer in order to rectify the dangerous condition which, without the Injury Reporting and Safety System, would go undetected. The Injury Reporting and Safety System may also be utilized to further limit the type of query to include all hand injuries caused by defective baggage carts at specific locations, such as at Philadelphia International Airport as opposed to searching all types of injuries at all Airports who utilize the system.

The Injury Reporting and Safety System also affords Labor and Industry the ability to analyze and compare repetitive causes of worksite injuries in order to promote safety not only on a local level but, as indicated above, also on a national level. Through networking industry data, local worksites such as Philadelphia International Airport may share information regarding similarly situated causes of repetitive injuries with workers who perform identical job duties at airports throughout the country.

The unique benefits of the Injury Reporting and Safety System also extend to industries such as the Building Trades, Communication Workers, Machinists or Transportation Workers. Building Trade Locals, such as plumbers and pipe fitters in one state often communicate and/or work with plumbers or pipe fitters in other states because of the frequency which interstate commerce occurs. Often workers conduct business with similar contractors, equipment and job sites despite being situated in different states.

Union plumbers and pipe fitters from the states of New Jersey, Maryland and Pennsylvania will often regularly conduct business within the state of Delaware under the jurisdiction of the Local Union situated in Delaware. As a result, Union plumbers and pipe fitters who are exposed to similar types of repetitive causes, sources and types of injuries throughout the country now have a mechanism to accurately report and record worksite injury data and information by complying with the step by step reporting process set forth in the Injury Reporting and Safety System.

The issues experienced by members of the building trades that work in multiple states and locations demonstrates how the Injury Reporting and Safety System enables each worker to have his worksite injury information reported and recorded at his or her respective Local or place of employment. The worksite injury information, as stated above, is reported to the computer data bank via telephone or by a co-worker onsite. The personalized Industry Reporting and Safety System Identification Card, which the worker keeps in his or her wallet, or other location “on the worker” provides an (800) telephone number in order to report the relevant information concerning his or her injury. This information is immediately incorporated into the Injury Reporting and Safety System database. As stated earlier, this Identification Card instructs the worker regarding the cause, source and type of worksite injury information to be communicated immediately following an incident. Once a data entry programmer receives the information, the process of recording same into the Injury Reporting and Safety System database and Incident Report is accomplished.

The information will include the name of the individual Union member, Local Union name, incident date, worker's address, telephone number and job duty classification. This information is pre-programmed in the Injury Reporting and Safety System in order to not only facilitate the report, but also identify the worker if he or she is working out of their jurisdiction and properly coordinate same. Thereafter, the worker will report the name of the facility/jobsite, contractors, location of accident, cause of accident, type of equipment, equipment manufacturer's identification number and name, body part injured and type of injury into the Injury Reporting and Safety System Incident Report categories which corresponds with those contained on the Identification Card. The Injury Reporting and Safety System affords a unique uniform framework for reporting and recording repetitive causes of worksite injuries and exposures within an industry because the Incident Report and Investigative Summary are consistent in form and content. A pull down menu is contained in the Injury Reporting computer program which may be utilized by the individual inputting the worksite cause and injury information for the designated categories. Each category's information is further designated a field and/or numerical code in order to be cross-referenced for safety and injury trend analysis. In addition, the Injury Reporting and Safety System also eliminates jurisdictional boundaries or inconsistencies in reporting and recording repetitive causes of worksite injuries.

Presently, apart from the Injury Reporting and Safety System, OSHA is the only mechanism which secures worksite injury data and as set forth above, this data is enormously limited, inefficient, inaccurate and unorganized. Never before the Injury Reporting and Safety System has such a comprehensive program been made available for labor or industry use in order to achieve safety and protect the legal rights of workers on not only a local but national level. Moreover, through the monitoring of repetitive causes and types of worksite injuries, the Injury Reporting and Safety System will provide industry specific data and information which can be furnished to contractors, government agencies, management and manufacturers, etc., in order to for these entities to correct and remedy dangerous and hazardous worksite conditions, equipment and exposures.

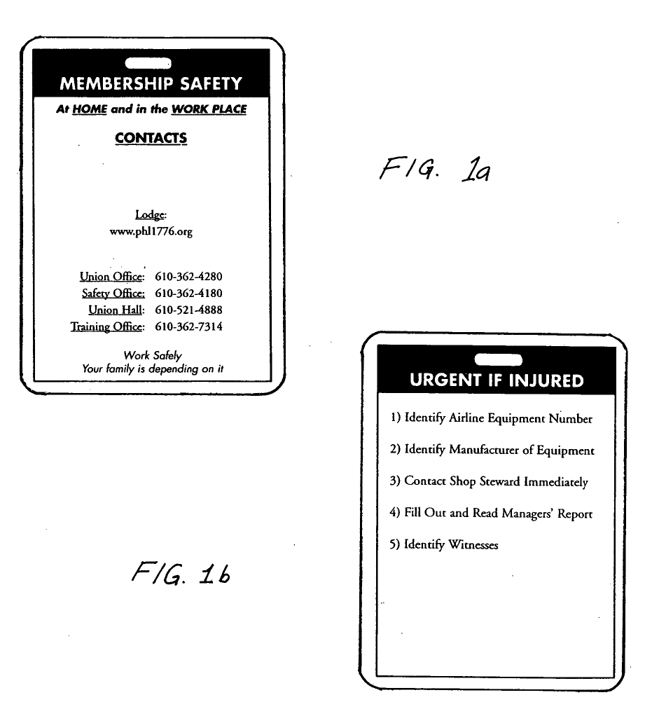

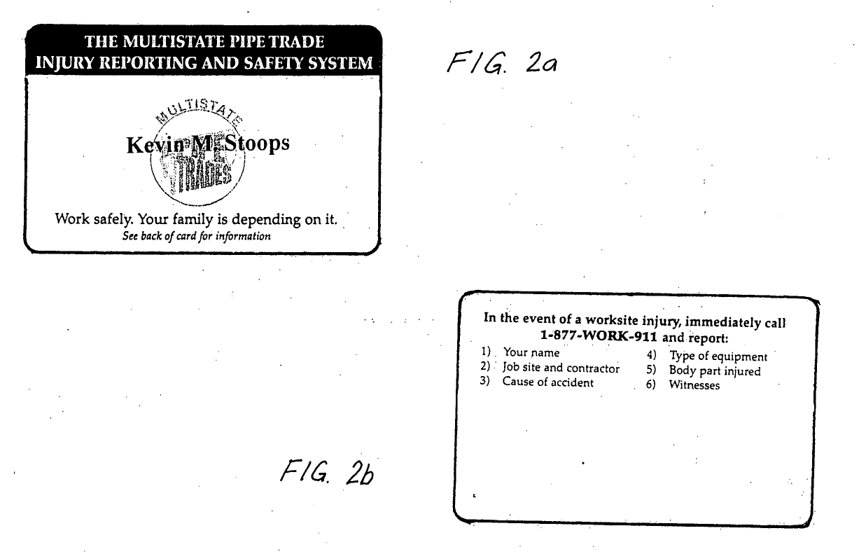

There is shown in FIGS. 1a and 1b an exemplary identification card for an airline worker showing front and back sides. The identification card shown in FIG. 1a includes contact information for the worker to report workplace injuries. FIG. 1b of the identification card lists the information that an injured worker (or co-worker) should obtain in reporting a workplace injury. In this exemplary embodiment, the injury reporting information is distributed between the two sides of a card. In addition, this exemplary embodiment has an attachment hole in the top to assist an airline worker in attaching the identification card to the workers badge, lanyard or other attachment means. It can also fit in pocket, wallet or purse. There is shown in FIGS. 2a and 2b an exemplary identification card for a pipe trade worker. In this embodiment, FIG. 2a lists the pipe trade workers name while FIG. 2b includes the contact information and workplace injury related information for a worker involved in a workplace injury. This exemplary identification card is sized to fit in a wallet or inside of identification card carrier or case, and may be laminated for protection. It would be understood by those skilled in the art that other ways of presenting the information on the card and means of carrying the identification card are possible. The airline and pipe trades were provided as examples of organizations that would benefit from the present invention, and not as limitations.

It is possible that a centralized tracking center can be used to receive and enter injury/accident reports for multiple work places/organizations. The identification and would then be helpful in identifying the worker, work place and organization.

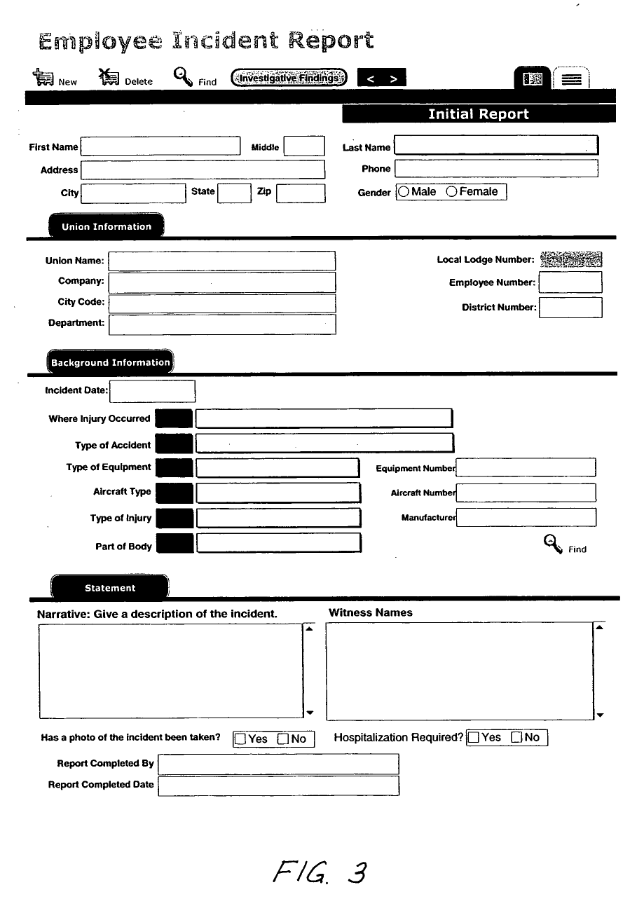

There is shown in FIG. 3 an employee incident report for use when an airline worker is injured. The employee incident report includes information about the injured worker and the worker's union/organization. In an exemplary embodiment, this information is preexisting in the database used in the present invention. All workers at a workplace will have their personal and union/organization information entered and maintained as a normal practice of their employment at the workplace and/or membership in the union/organization. This information can then be easily populated into the employee incident report when a workplace injury is first reported by typing in the employee's name, employee number or other unique identifier. Alternatively, this information can be entered by the intake person receiving the information from the employee or co-worker at the time of a workplace injury being reported.

Other information to be entered into the employee incident report includes information that tracks the information requested of the injured worker on the identification card (i.e., for an airline worker in FIGS. 1a and 1b). For example, the identification card in FIGS. 1a and 1b requests the injured worker to identify the airline equipment number and the manufacturer of the equipment. Included in the information to be entered into the employee incident report, is the airline equipment number and the manufacturer. Other information will be obtained from the injured worker including the type of accident, type of injury and part of body. In this exemplary employee incident report, the injured worker will also be asked for a description of the incident, witness names, whether a photograph or other documentation of the injury has taken place and whether hospitalization is required of the injured worker. By dating the report, evidence of a contemporaneous report to an injury can be shown. Information required for an employee incident report can be tailored to the particular workplace, types of injury and types of employees.

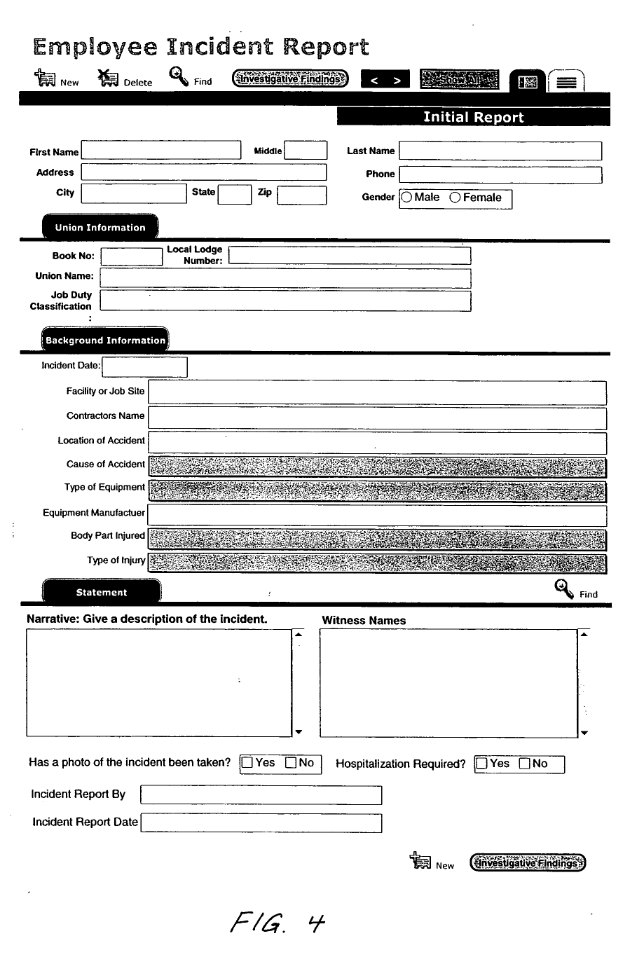

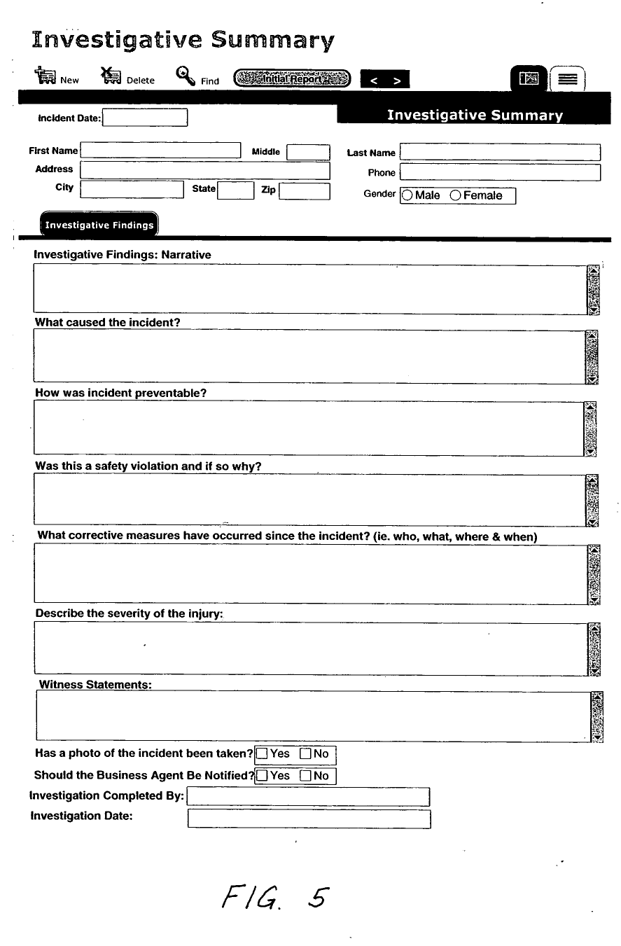

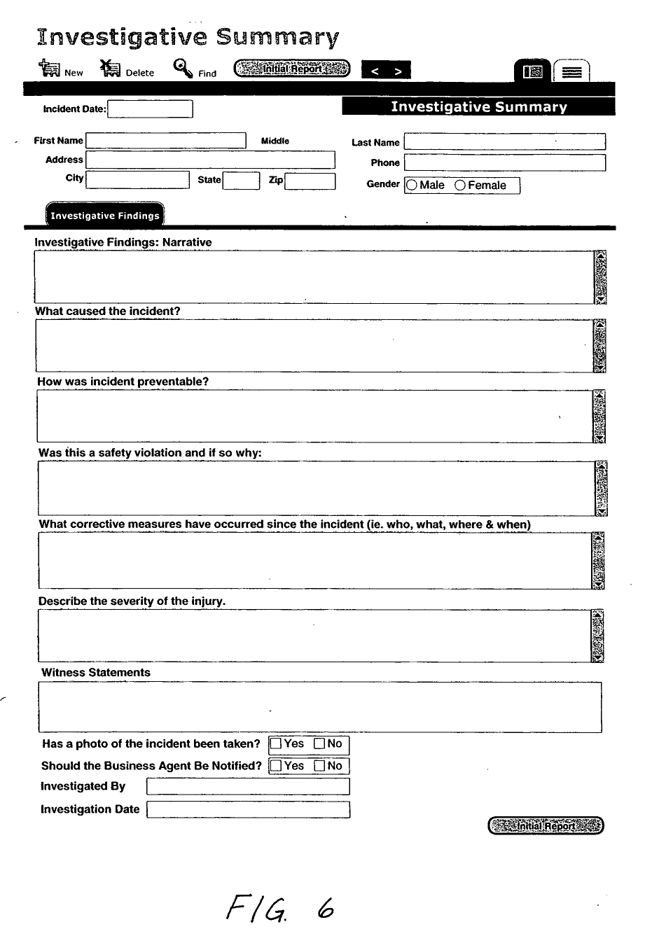

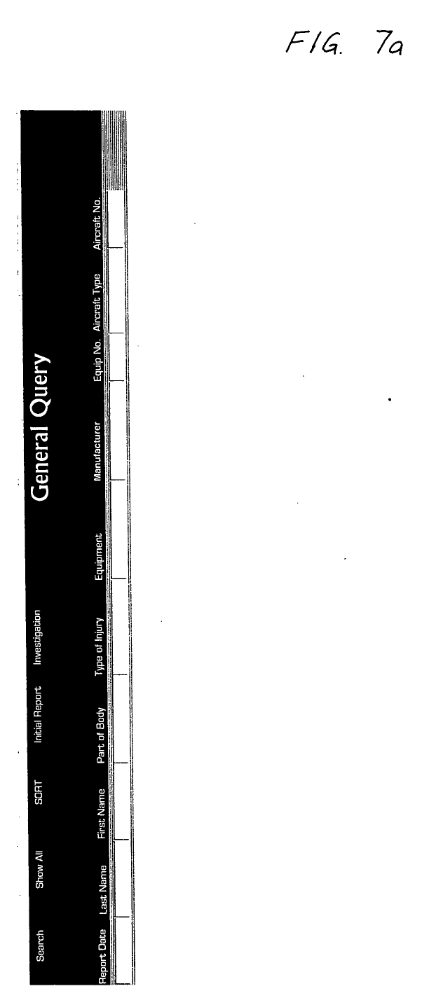

There is shown in FIG. 4 an exemplary employee incident report for a pipe trade worker. As in FIG. 3, information about the employee and the employee's union/organization can be automatically populated into this system from an existing database of employee information or entered directly by the operator. This incident report includes questions tied to the identification card for a pipe trade worker shown in FIGS. 2a and 2b. Examples of these questions (tailored for a pipe trade worker) include the job site and contractor name, cause of accident, type of equipment, body part injured and witnesses.

There is shown in FIG. 5 an example of an investigative summary entry screen for an airline industry worker. The investigative entry screen includes information tying the investigative report to the injured worker. A list of investigative findings corresponding to the type of accidents common to that particular workplace/type of worker are included. This exemplary investigative entry screen includes investigative findings, cause of the accident, was the incident preventable, was this a safety violation, what corrective measures have occurred since the incident, severity of the injury and witness statements. Like the employee incident report entry form (i.e., FIGS. 3 and 4), the investigative report also has a date field to evidence that the investigation was completed contemporaneous to the report of the accident. It will also allow tracking by date to issue an investigation has been completed. There is shown in FIG. 6 an exemplary investigative summary entry screen for a pipe trade worker injury.

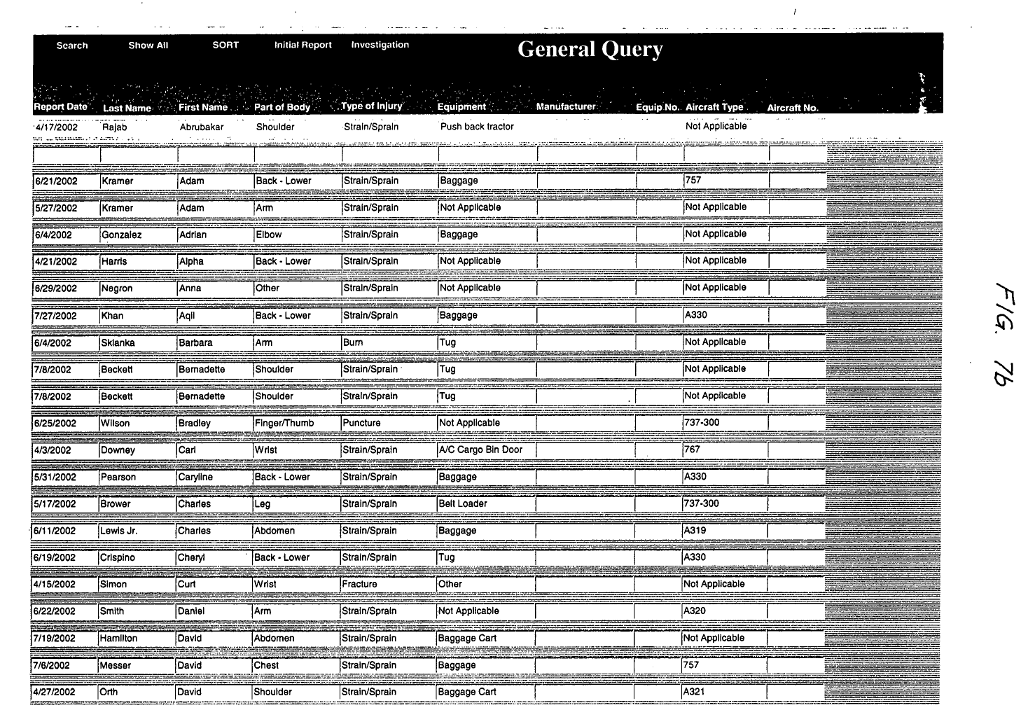

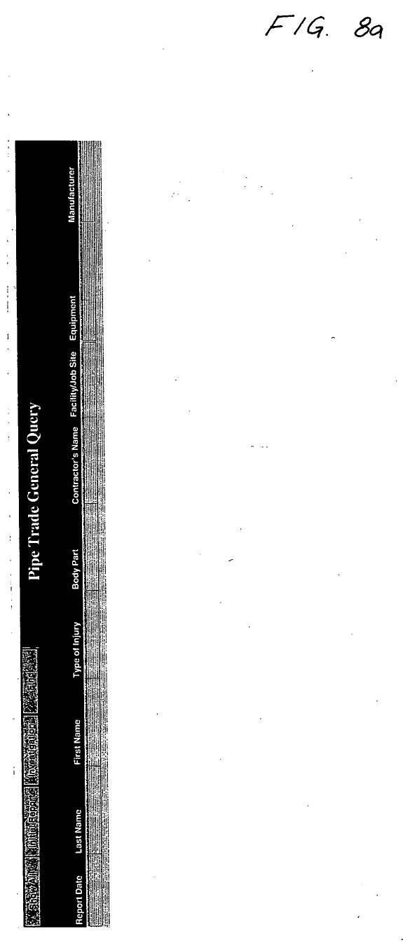

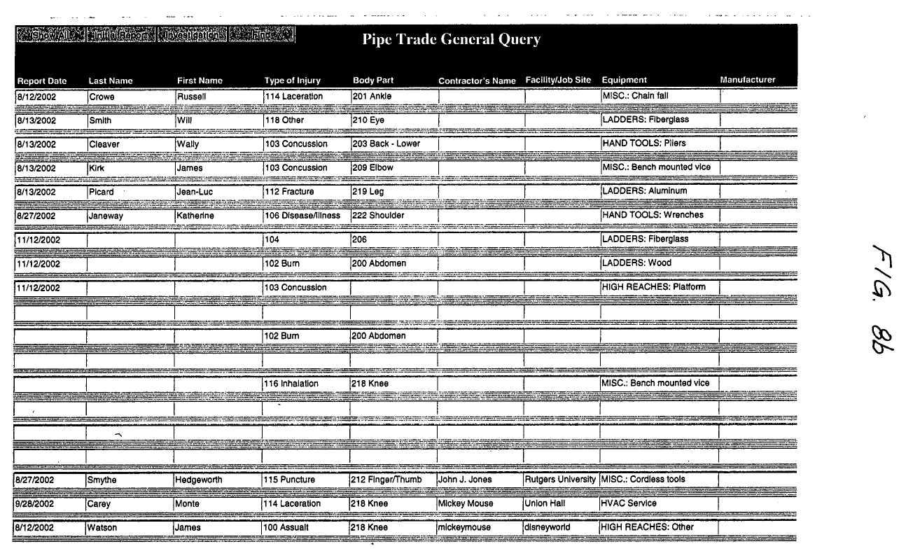

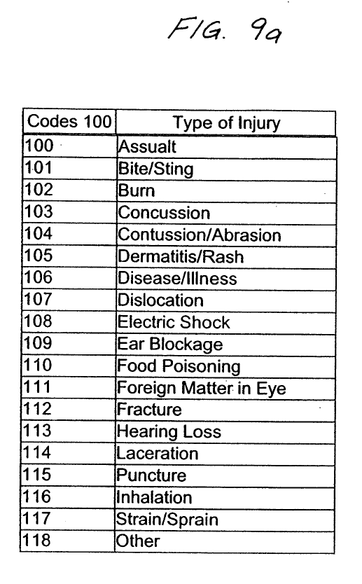

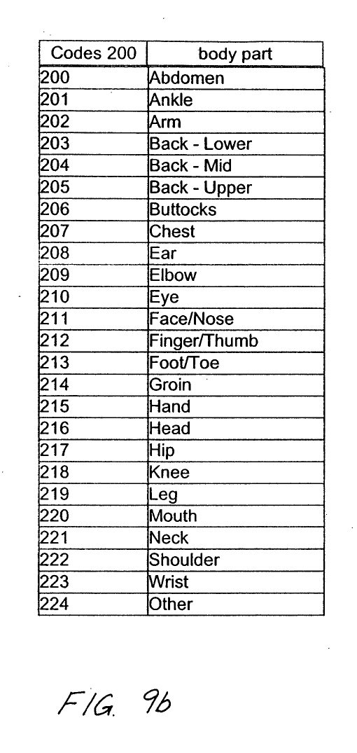

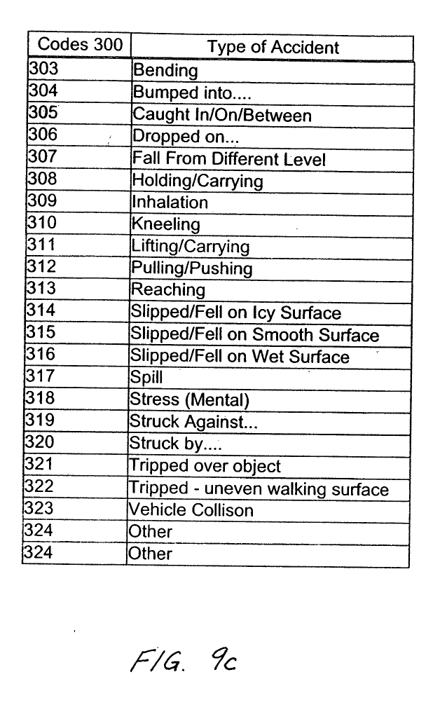

There is shown in FIG. 7a an exemplary database query entry screen for an airline industry database query. This exemplary database query entry screen has fields consistent with the workplace, type of work, or type of injury of an airline industry worker. This screen allows a permitted user to access information concerning workplace injuries in the database.

There is shown in FIG. 7b an exemplary airline industry database query screen with industry examples filled in. While the manufacturing aircraft number fields are blank, this is information that may be entered, depending on the type of injury/machinery involved.

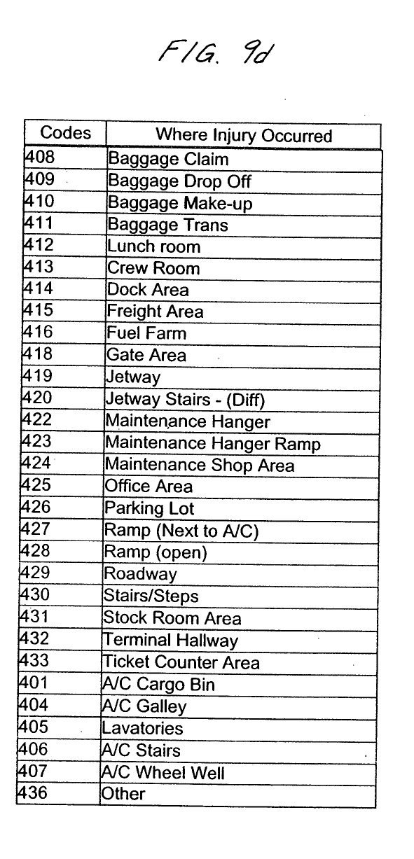

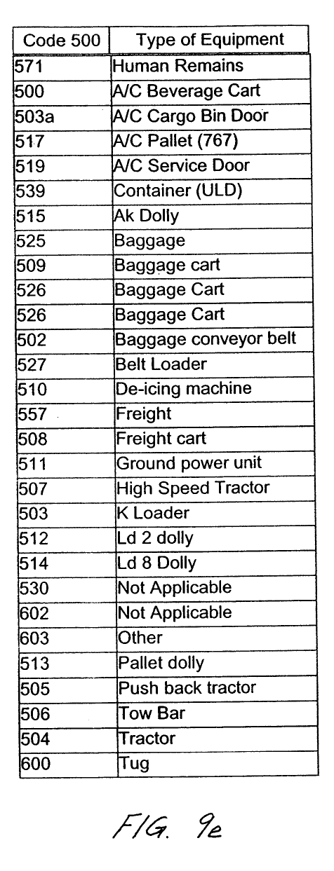

There is shown in FIG. 8a an exemplary pipe trade industry database query entry screen. This entry screen has fields pertinent to the type of workplace/worker involved in the pipe trades.

There is shown in FIG. 8b an exemplary pipe trade industry database query entry screen with industry examples. As can be seen, some of the data in the fields includes codes for the type of injury and the body part. The incident report entry screens have pull down menus for some of the fields with pre-approved descriptions and codes to help facilitate speedy and accurate reporting of injuries and their cause.

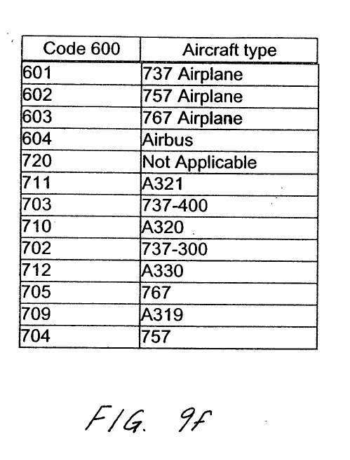

There is shown in FIGS. 9a-f a series of injury and accident descriptions with corresponding codes. As noted earlier, these tables help facilitate the entry of accident and injury reporting so that there is clarity, consistency, and accuracy. The use of codes associated with an injury or accident provide for ease in tracking injuries and accidents.

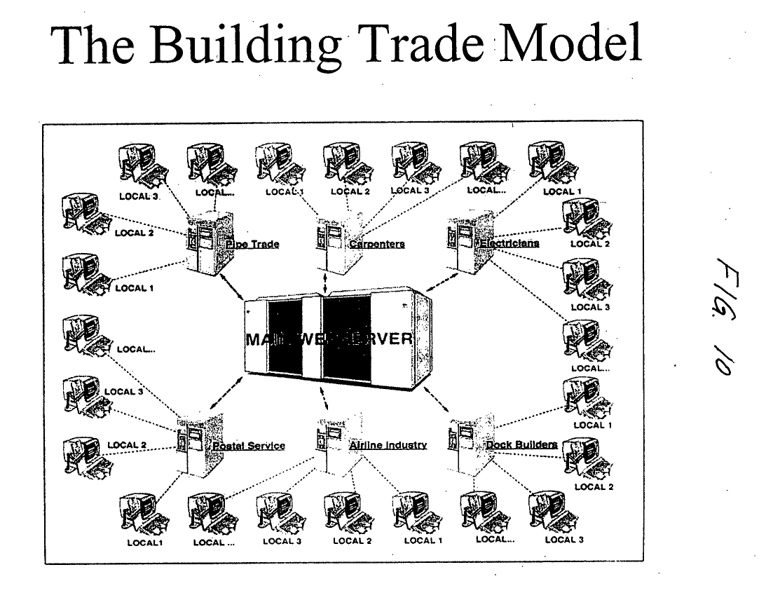

There is shown FIG. 10 a flow diagram illustrating how data and information may be exchanged and networked by labor and industry and in accordance with the present invention. In FIG. 10, additional work groups beyond the airline industry and the pipe trade are shown as examples. This will be particularly helpful in workplaces where multiple group/organizations have workers.

Accompanying are software code/routines in accordance with the present invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method of monitoring workplace injuries of workers comprising the steps of:
a) providing an information card for at least one of the workers at a workplace, the information card containing instructions on how and where to report a workplace injury of an injured worker;
b) providing a database entry form for entering the report of a workplace injury of an injured worker into a database, with first data entry fields that correspond to one or more of the instructions on the information card and second data entry fields that direct questions to be asked of the injured worker; and
c) providing a query facility to query the database regarding the data stored in the database relating to workplace injuries.

2. A method of monitoring workplace injuries in accordance with claim 1 comprising the additional step of providing an investigation summary form for recording results of an investigation of the workplace injury and entering the results into the database.

3. A method of monitoring workplace injuries of workers in accordance with claim 1 comprising the further step of providing a summary report of each workplace injury reported.

4. A method of monitoring workplace injuries of workers in accordance with claim 1 wherein the workers have worker representatives, the workplace has workplace representatives, the workplace is related to an industry and the industry has industry representatives, comprising the further step of allowing one or more of: the workers, the worker representatives, the workplace representatives and the industry representatives to query the database through the query facility to review reported injury data.

5. A method of monitoring workplace injuries of workers in accordance with claim 1 wherein the instructions on the information card are directed to the specific workplace of the workers.

6. A method of monitoring workplace injuries of workers in accordance with claim 1 wherein the information card is provided to substantially all workers at the workplace.

7. A method of monitoring workplace injuries of workers in accordance with claim 6 wherein the workplace includes a plurality of specific jobs for the workers and there are a corresponding plurality of types information cards, each of the plurality of types information cards directed at a corresponding one of the specific jobs.

8. A method of monitoring workplace injuries of workers in accordance with claim 1 wherein background information for each of the workers is stored in the database and accessible for automatic entry into the database entry form when a workplace injury is reported.

9. A method of monitoring workplace injuries of workers in accordance with claim 1 comprising the further step of determining trends of specific injuries at the workplace.

10. A method of monitoring workplace injuries of workers in accordance with claim 1 comprising the further step of determining trends of specific causes of injuries at the workplace.

11. A method of monitoring workplace injuries of workers in accordance with claim 1 comprising the further step of querying the database relating to workplace injuries for use in pursuing legal remedies for injured workers.

12. A method of monitoring workplace injuries of workers in accordance with claim 1 wherein step (b) comprises the further step of providing predetermined categories for entry in at least one of the data fields.

13. A system for monitoring workplace injuries of workers comprising:
a) an information card for at least one of the workers at a workplace, the information card containing instructions on how and where to report a workplace injury of an injured worker;
b) a database entry form for entering the report of a workplace injury of an injured worker into a database, with first data entry fields that correspond to the instructions on the information card and second data entry fields that direct questions to be asked of the injured worker;
c) a query facility to query the database regarding the data stored in the database relating to workplace injuries.

14. A method of monitoring workplace injuries of workers comprising the steps of:
a) providing an information card for at least one of the workers at a workplace, the information card containing instructions on how and where to report a workplace injury of an injured worker;
b) providing a database entry form for entering the report of a workplace injury of an injured worker into a database, with first data entry fields that correspond to one or more of the instructions on the information card and second data entry fields that direct questions to be asked of the injured worker;
c) providing an investigation summary form for recording results of an investigation of the workplace injury and for entering the results into the database; and
d) providing a query facility to query the database regarding the data stored in the database relating to workplace injuries.

15. A method of monitoring workplace injuries of workers comprising the steps of:
a) providing an information card for at least one of the workers at a workplace, the information card containing instructions on how and where to report a workplace injury of an injured worker; and
b) obtaining information related to the workplace injury and reporting the workplace injury by following the instructions contained on the information card.

16. A method of monitoring workplace injuries of workers comprising the steps of:
a) reporting providing an information card for at least one of the workers at a workplace, the information card containing instructions on how and where to report a workplace injury of an injured worker;
b) entering information concerning a workplace injury of an injured worker into a database through a database entry form, the database entry form having first data entry fields that correspond to one or more of the instructions on an information card provided to one or more of the workers and second data entry fields that direct questions to be asked of the injured worker; and
c) entering information concerning the workplace injury into a database through an investigation summary form.

17. A method of monitoring workplace injuries of workers comprising the steps of:
a) reporting providing an information card for at least one of the workers at a workplace, the information card containing instructions on how and where to report a workplace injury of an injured worker;
b) entering information concerning a workplace injury of an injured worker into a database through a database entry form, the database entry form having first data entry fields that correspond to one or more of the instructions on an information card provided to one or more of the workers and second data entry fields that direct questions to be asked of the injured worker;
c) entering information concerning the workplace injury into a database through an investigation summary form; and
d) querying the database regarding the data stored in the database relating to workplace injuries.
